(19) United States
(12) Patent Application Publication
(10) Pub. No.: US 2019/0138712 A1
(43) Pub. Date: May 9, 2019

(54) SYSTEMS AND METHODS FOR REAL-TIME DATA PROCESSING ANALYTICS ENGINE WITH ADAPTIVE COMPONENT SERVICES

(71) Applicant: ADNOMUS, INC., SAN JOSE, CA (US)

(72) Inventor: Christos Margiolas, San Jose, CA (US)

(21) Appl. No.: 15/994,838

(22) Filed: May 31, 2018

Related U.S. Application Data
(60) Provisional application No. 62/513,158, filed on May 31, 2017.

(51) Int. Cl. G06F 21/53; G06N 20/00; G06F 9/445; G06F 8/65; G06F 21/44; G06F 21/57; G06F 21/56

(52) U.S. Cl. CPC G06F 21/53; G06N 20/00; G06F 9/44521; G06F 2221/033; G06F 21/44; G06F 21/57; G06F 21/562; G06F 8/65

(57) ABSTRACT

Example implementations are directed to systems and methods to load a native library including a core library in an isolated execution environment sandbox; periodically request an updated version of the core library from a registry; in response to requests from the application, authenticate the request via an interaction filter and validate information from the updated version of the core library for the request; and deliver the validated information to the application.

This application claims priority under 35 USC 119 based on U.S. Provisional Patent Application No. 62/513,158, filed on May 31, 2017, the contents of which is incorporated herein in its entirety by reference.

### 1. TECHNICAL FIELD

The embodiments described herein are related to data analytics and more specifically to content characterization using artificial intelligence.

### 2. BACKGROUND

People spend more time using connected applications for interacting with social media, online shopping, messaging, sharing content, etc. that results in more data being processed in different locations. Further, conventional computing services and essential utilities have evolved to be remotely accessible in order to reduce onsite processing and maintenance costs among a number of other benefits. With the proliferation of distributed computing, conventional approaches to managing software access control have been shown to be inadequate to ensure security.

Applications with network connectivity are typically designed to access third-party services via the network connection to leverage remote resources or interface with separately hosted modules. For example, conventional mobile applications are designed to interface with third-party services such as traffic services, weather updates, shopping inventories, etc. Third-party services vary depending on the application across a spectrum of technology areas such as Internet of Things (loT), mobile devices, data center nodes, virtual computing, super-computing, etc.

Conventionally, applications access third-party services as a library (e.g., a software development kit), a network accessible resource, an Operating System resource (e.g., system call, special filesystem entries), etc. As used herein, library may refer to different methods for implementing third-party services known in the art. For example, a software development kit (SDK) is a set of software development tools that allows for the creation of applications for a certain software package, software framework, hardware platform, computer system, etc. SDKs are commonly used to enrich applications with advanced functionalities, advertisements, push notifications, etc. SDKs are conventionally implemented within applications running as independent code with reliance on independent libraries. Therefore, SDKs are a common security threat and are generally not trustworthy. For example, malicious SDKs may violate data privacy policies, harm an application's performance, cause damage to a device, etc.

### BRIEF DESCRIPTION OF THE DRAWINGS

Features, aspects, and embodiments are described in conjunction with the attached drawings, in which:

The structure and operation of the example implementations will be understood from a review of the following detailed description and the accompanying drawings in which like reference numerals refer to like parts and in which:

FIG. 1 illustrates an overview of a system in accordance with an example implementation.

FIG. 2 illustrates an example Third-Party System Infrastructure in accordance with an example implementation.

FIG. 3 illustrates an example implementation for adaptive component services.

FIG. 4 illustrates a flow diagram of an example sequence in accordance with an example implementation.

FIG. 5 illustrates an example analytics flow diagram in accordance with an example implementation.

FIG. 6 illustrates an example server computing environment with an example computer device suitable for use in example implementations.

FIG. 7 illustrates an example networking environment with example computer devices suitable for use in example implementations.

FIG. 8 illustrates a block diagram of an example computing device or system that may be used in connection with various example implementations described herein.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Example aspects facilitate systems and methods to load a native library including a core library in an isolated execution environment sandbox; periodically request an updated version of the core library from a registry; in response to requests from the application, authenticate the request via an interaction filter and validate information from the updated version of the core library for the request; and deliver the validated information to the application.

In an example implementation, a system includes a memory; one or more processors coupled to the memory, wherein the processor is configured to operate a secure core module to provide native information in response to application requests while performing in an isolated execution environment sandbox, where the secure core module is periodically updated with information from an insecure registry, and where the application requests are received from a an interaction filter that validates and forwards validated requests to the application requests to the secure core module.

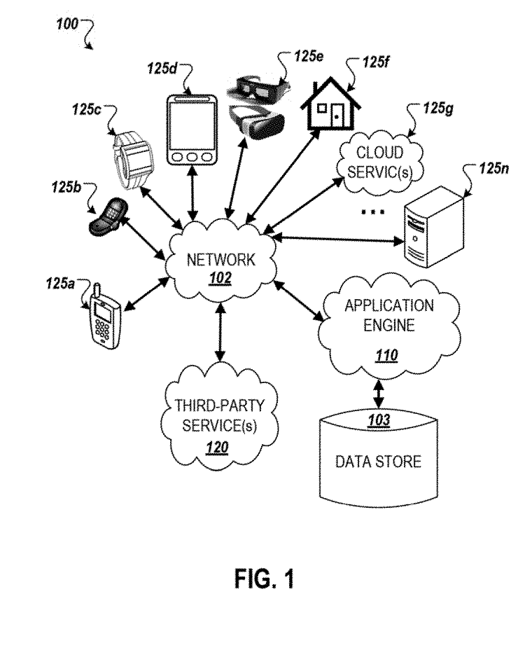

FIG. 1 illustrates an overview of a system 100 in accordance with an example implementation. The system 100 includes an application engine 110 configured to interact with one or more third-party services 120.

A third-party service 120 can communicate with one or more client devices 125a-125n to provide content and/or updates to applications running on client devices 125a-125n. In accordance with embodiments described herein, the application engine 110 can describe a computing environment remotely connected to the third-party services 120 or be hosted locally as an environment on client devices 125a-125n accessing the third-party services 120.

The application engine 110 may be implemented in the form of software (e.g., instructions on a non-transitory computer readable medium) running on one or more processing devices, such as the one or more client, as a cloud service 125g, remotely via a network, as part of the publisher network(s) 120 or other configuration known to one of ordinary skill in the art.

The computing environment of the application engine 110 can be hosted by a client device (e.g., client device 125a-125n), remote servers (e.g., server 125X). third-party databases, or other configuration known to one of ordinary skill in the art. Data associated with the user or a client device of the application may interact with third-party services on different types of client devices 125a-125n. Client devices 125a-125n can include, for example, handheld digital devices 125a, mobile phones 125b, wearable technology 125c (e.g., fitness trackers, location sensors, GPS units, Bluetooth® beacons, etc.), mobile computing devices 125d (e.g., laptops, tablets, etc.), virtual and augmented reality devices 125e, computing devices 125n (e.g., desktops, mainframes, network equipment, etc.), location based systems 125f (e.g., control systems, building environment control devices, security systems, corporate infrastructure, smart environments, etc.), as well as cloud services 125g (e.g., remotely available proprietary or public computing resources).

The terms “computer”, “computer platform”, “computing environment”, processing device, and client device are intended to include any data processing device, such as a desktop computer, a laptop computer, a tablet computer, a mainframe computer, a server, a handheld device, a digital signal processor (DSP), an embedded processor, or any other device able to process data. The computer/computer platform is configured to include one or more microprocessors communicatively connected to one or more non-transitory computer-readable media and one or more networks.

The application engine 110 directly or indirectly includes memory such as a data store 103 (e.g., RAM, ROM, and/or internal storage, magnetic, optical, solid state storage, and/or organic), any of which can be coupled on a communication mechanism (or bus) for communicating information.

In an example implementation, the application engine 110 can be communicatively connected to the third-party services 120 via a network 102 to receive independent data. The term “communicatively connected” is intended to include any type of connection, wired or wireless, in which data may be communicated. The term “communicatively connected” is intended to include, but not limited to, a connection between devices and/or programs within a single computer or between devices and/or separate computers over the network 102. The term “network” is intended to include, but not limited to, packet-switched networks such as local area network (LAN), wide area network (WAN), TCP/IP, (the Internet), and can use various means of transmission, such as, but not limited to, WiFi®, Bluetooth®, Zigbee®, Internet Protocol version 6 over Low-power Wireless Area Networks (6LowPAN), power line communication (PLC), Ethernet (e.g., 10 Megabyte (Mb), 100 Mb and/or 1 Gigabyte (Gb) Ethernet) or other communication protocols.

Third-party service 120 can include client data gathering services with functionality, for example, to collect, track, transmit, and/or store independent computer code or resources (e.g., content), and so forth.

Client devices 125a-125n may also host third-party services for one or more other client device 125a-125n and provide the intendent content, directly or indirectly, to the application engine 110. For example, client devices 125a-125n can be communicatively connected to the other client device using WiFi®, Bluetooth®, Zigbee®, Internet Protocol version 6 over Low-power Wireless Area Networks (6LowPAN), power line communication (PLC), Ethernet (e.g., 10 Megabyte (Mb), 100 Mb and/or 1 Gigabyte (Gb) Ethernet) or other communication protocols.

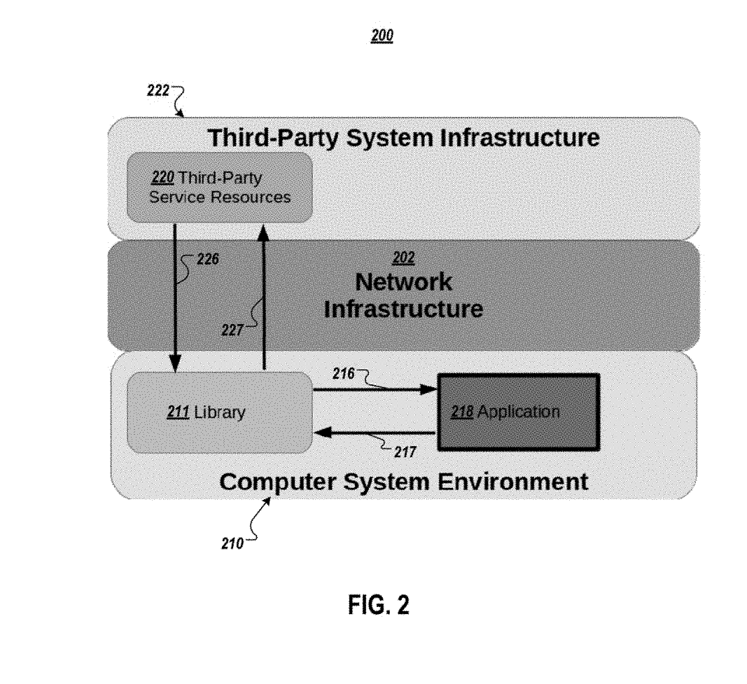

FIG. 2 illustrates an example Third-Party System Overview 200 in accordance with an example implementation. Third-Party System Infrastructure 222 is a set of remote computing resources that host the Third-Party Service Resources 220. The Application 218 runs on a Computer System Environment 210 (e.g., a specific hardware platform with an operating system and a set of libraries and execution environments) and uses the Library 211 to access the Third-Party service 220. The Library 211 uses a network infrastructure 202 to contact 226, 227 the Third-Party Resources 220. Conventional approaches, such as depicted in 200, lack the fundamental functionality required to ensure security with real-time performance in modern systems.

For example, software updates are very frequent operations either for adding new functionality or providing security fixes. A service access component uses certain types of updates, for example, to fix a bug or add a new feature. The standard development and deployment practices (e.g. application development policies for mobile platforms or “smartphones”) introduce delays of weeks if not months before a new update is available and installed prohibiting support for instant updates/fixes.

Further, applying software updates currently requires some level of human involvement, typically for software development, system administration, user approval etc. with different procedures that may be incompatible. The use of a third-party service typically dictates the transfer of data and, in many cases, the execution of code originating from the third-party service on the computer system of the application. The interaction is conventionally not formally defined and lacks security checks to apply and enforce safe execution of third-party code.

Moreover, services are poorly integrated with applications running on diverse systems. For example, each system typically introduces different hardware and software architectures that require different standards to be followed. In many conventional cases, the software is written in different languages requiring development of a dedicated Service Access Component for every system. Therefore, systems suffer from error-prone implementations (many vs one well tested implementation), high development costs and significant service operation complexity.

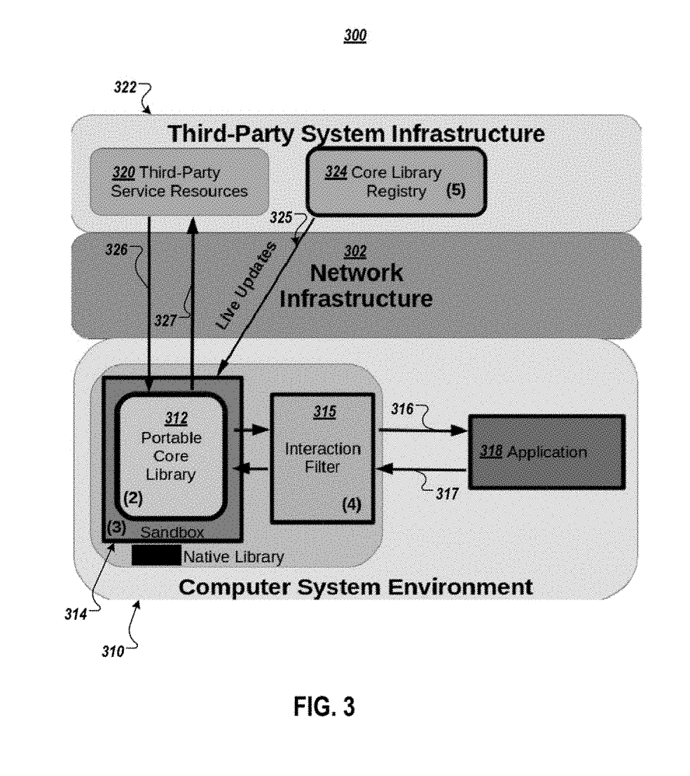

Accordingly, a portable process of designing and developing Service Access Components that minimizes system specific integrations is illustrated in FIG. 3.

FIG. 3 illustrates an example implementation for adaptive component services 300. The adaptive component services 300 provides service access components that introduce low communication and computation overheads while relying on stable and well-established technologies. The adaptive component services 300 includes a set of components, the Native Library 311) a Portable Core Library 312, a Sandbox 314, an Interaction Filter 315, and a Core Library Registry 324.

The Native Library 311 interfaces with the application 318 (e.g., application engine 110 of FIG. 1) and enables access to the third-party service 322 (e.g., Third-party Services 120 of FIG. 1). The Native Library 311 includes a sandbox environment (e.g., Sandbox 314) which can be a web browser engine or a container technology. That is, the adaptive component services 300 do not rely on a monolithic library design.

The Native library 311: provides service access to the Application 318 and contains the Sandbox 314 environment (Sandbox 314) and the Interaction Filter. The Native library 311 is specified based on the native technologies and languages on each platform. For example, on Android based operating system, a Java™ programming language is employed for Native library 311 via the Android SDK. In another example, on an Apple iPhone® operating system (iOS®) a Native library 311 for the Swift language is used for the iOS SDK. By adapting the Native library 311 for the platform specific component, the remaining components are platform agnostic.

Portable Core Library 312 provides a library implementation in a portable language/representation that is transferrable over the network and compatible to be executed on any platform. For example, the language/representation can be Javascript code, Java bytecode or WebAssembly. The Portable Core Library 312 provides the core functionality for accessing the Third-Party service.

Sandbox 314: component is responsible for the isolated execution of the Portable Core Library 312 that is receive from the Third-Party 322 over the network at 326. The Sandbox 314 can be a web browser engine, a container technology such as Docker or LXC, a Javascript execution environment as node.js or a hypervisor-based Virtual Machine.

The Sandbox 314 supports the isolated execution of a Portable Core Library 312 that is retrieved on-the-fly and instantly (e.g., when there is an update) from the Core Library Registry 324. The Core Library Registry 324 resides on the Third-Party Infrastructure 322. For example, the Sandbox 314 can be a Docker or a hypervisor-based virtual machine (KVM, Xen). The virtual machine (VM) is a portion of software that, when executed on appropriate hardware, creates an environment allowing the virtualization of an actual physical computer system (e.g., a server, a mainframe computer, etc.). A virtual machine may function as a self-contained platform, executing as a “guest” operating system and software applications. Software on the host machine is typically referred to as a “hypervisor” (or a “virtual machine monitor”) that manages the execution of one or more virtual machines, providing a variety of functions such as virtualizing and allocating resources, context switching among virtual machines, etc.

The Sandbox 314 identifies an interface (e.g. network sockets, shared memory, etc.) that permits the Portable Core Library 312 to interact with external resources on the system. The identified interface enables the Portable Core Library 312 to interact with the Application 318. In an example implementation, an Interaction Filter component 315 is used to enforce security checks and apply the data/request transformations. The Sandbox 314 exclusively allows the Portable Core Library 312 to communicate with external resources on the systems by a well-defined interface (e.g., a number of network sockets or shared memory). Communication between the Portable Core Library 312, the Native library 311 and indirectly the Application 318 takes place over that interface.

The Native library 311 interfaces with the Application 318 via a defined Binary Interface and/or Network Sockets 316, 317 while the Sandbox 314 can exposes a different interface 326, 327 to the Portable Core Library 312. Separate interface via the Interaction Filter 315 bridges the two interfaces (e.g., 316-317 and 326-327) by performing the required data transformations (e.g. convert a string from a Javascript representation to a C/C++ one). The Interaction Filter 315 performs security and sanity checks regarding the interface operations.

For example, the library developer describes the semantics of every expected function call or network request in a domain specific language and the Interaction Filter 315 can perform checks each time there is a new interaction between the Portable Core Library 312, the Native Library 311 and the Application 318.

The Core Library Registry 324 resides on the Third-Party Infrastructure 322 and distributes the updates (i.e., version control) of the Portable Core Library 312. For example, the library developer can push an update when a new features or security fixes is available and a new version of the Portable Core Library 312 is distributed via the Core Library Registry 324. The Core Library Registry 324 notifies the end clients of the service to retrieve the new version of the core library.

In an example implementation, instant updates for new functionality and security fixes can be distributed in response to a new Portable Core Library 312 that is pushed out via the Core Library Registry 324. Then the Core Library Registry 324 propagated the new Portable Core Library 312 to each client of the service.

Thereby the adaptive component services 300 provides seamless updates (e.g., new updates/versions) of the library coming from the Core Library Registry 324 are fetched seamlessly and executed by the Sandbox 314 without human interaction. The adaptive component services 300 also provides well defined and secure service-application interaction via the Portable Core Library 312 that operates inside the secure and isolated Sandbox 314. The Sandbox 314 exposes a well-defined interface to the Portable Core Library 312 and the Interaction Filter 315 protects the required data transformations and ensures that the semantics of the library-application interaction are respected. Thus, a portable, low-risk implementation is provided in a portable representation (Portable Core Library 312) that is compatible with across the systems of the clients and the Native Library 311 ensures platform specific integrations.

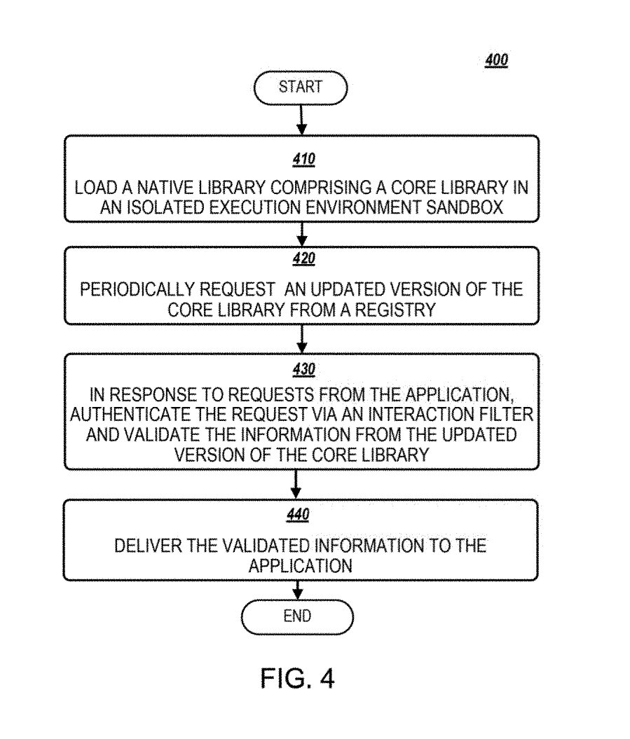

FIG. 4 illustrates a flow diagram of an example sequence 400 in accordance with an example implementation. At block 410, the processing device loads a native library including a core library in an isolated execution environment sandbox. At block 420, the processing device periodically requests an updated version of the core library from a registry. At block 430, the processing device in response to requests from the application, authenticates the request via an interaction filter and validates information from the updated version of the core library for the request. At block 440, the processing device delivers the validated information to the application.

According to an example implementation, the application (318) boots and loads the Native Library (311). The Native Library (311) contacts the Core Library Registry (324), requests and downloads the latest version of the Portable Core Library (312). The Portable Core Library (312) gets initialized and serves application requests while performing in an isolated execution environment sandbox (314). The application (318) performs requests by calling the Native Library (311). The Interaction Filter (318) of the Native Library (311) validates and forwards the application requests to the Portable Core Library (312) while also insuring that the application receives valid responses. The native library periodically checks with the Core Library Registry (324) for new versions of the Portable Core Library (312) and receives any updated version.

In an example implementation, a system includes a memory; one or more processors coupled to the memory, wherein the processor is configured to operate a secure core module to provide native information in response to application requests while performing in an isolated execution environment sandbox, where the secure core module is periodically updated with information from an insecure registry, and where the application requests are received from a an interaction filter that validates and forwards validated requests to the application requests to the secure core module.

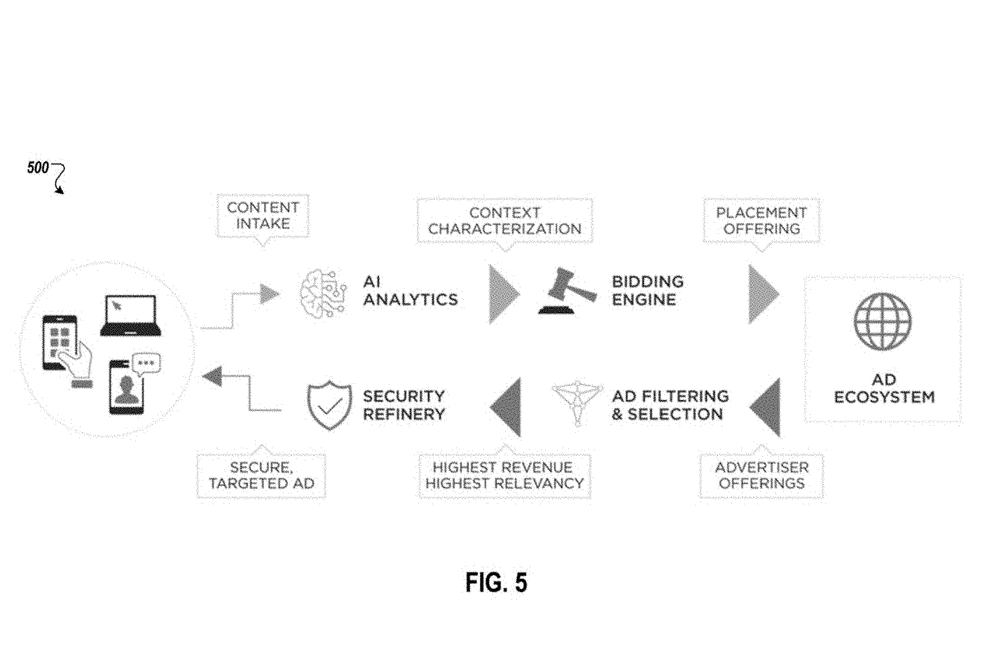

FIG. 5 illustrates an example analytics platform 500 to implement the component access service. In an example, the adaptive component services of the application engine 110 can be implemented in an analytics platform 500 that facilitates an auctioned transfer of content in different formats to provide real-time services for to process data.

In the example, the analytics platform 500 includes a high-level presentation of the functionality of the analytics engine. The analytics platform 500 can receive content, for example content submissions from the content providers via a portal, API, or device (e.g. laptop, mobile device, etc.), filters out sensitive content that is malicious or low-quality, performs quality categorization and contextual analyses. In the example, the analytics platform 500 uses machine-learning techniques and artificial intelligence driven technology to operate as a characterization and recommendation system for supplemental content.

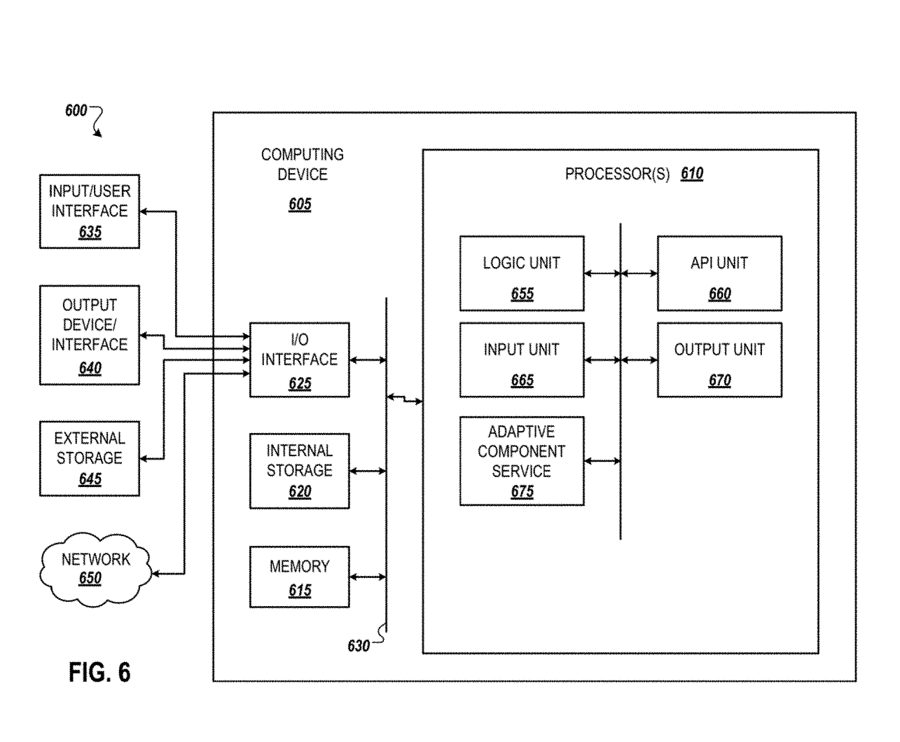

FIG. 6 shows an example computing environment with an example computing device associated with the external host for use in some example implementations. Computing device 605 in computing environment 600 can include one or more processing units, cores, or processors 610, memory 615 (e.g., RAM, ROM, and/or the like), internal storage 620 (e.g., magnetic, optical, solid state storage, and/or organic), and/or I/O interface 625, any of which can be coupled on a communication mechanism or bus 630 for communicating information or embedded in the computing device 605.

Computing device 605 can be communicatively coupled to input/user interface 635 and output device/interface 640. Either one or both of input/user interface 635 and output device/interface 640 can be a wired or wireless interface and can be detachable. Input/user interface 635 may include any device, component, sensor, or interface, physical or virtual, that can be used to provide input (e.g., buttons, touchscreen interface, keyboard, a pointing/cursor control, microphone, camera, braille, motion sensor, optical reader, and/or the like).

Output device/interface 640 may include a display, television, monitor, printer, speaker, braille, or the like. In some example implementations, input/user interface 635 and output device/interface 640 can be embedded with or physically coupled to the computing device 605. In other example implementations, other computing devices may function as or provide the functions of input/user interface 635 and output device/interface 640 for a computing device 605.

Examples of computing device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 605 can be communicatively coupled (e.g., via I/O interface 625) to external storage 645 and network 650 for communicating with any number of networked components, devices, and systems, including one or more computing devices of the same or different configuration. Computing device 605 or any connected computing device can be functioning as, providing services of, or referred to as a server, client, thin server, general machine, special-purpose machine, or another label.

The I/O interface 625 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

I/O interface 625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computing device 605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 655, application programming interface (API) unit 660, input unit 665, output unit 670, and adaptive component engine 675. For example, input unit 665, and adaptive component engine 675, may implement one or more processes shown in FIGS. 1-2. The described units and elements can be varied in design, function, configuration, or implementation and are not limited to the descriptions provided.

In some example implementations, the adaptive component engine 675 operates on a client device such as 125a-125n of FIG. 1 In some example implementations, when information or an execution instruction is received by API unit 660, it may be communicated to one or more other units (e.g., logic unit 655, output unit 670, input unit 665, and adaptive component engine 675).

Input unit 665 may, via API unit 660, interact with the adaptive component engine 675, to provide the input information. Using API unit 660, adaptive component engine 675 and, the system publish updates to third-party services independent of platform requirements, for example.

In some instances, logic unit 655 may be configured to control the information flow among the units and direct the services provided by API unit 660, input unit 665, output unit 670, input unit 665, adaptive component engine 675, in some example implementations described above. For example, the flow of one or more processes or implementations may be controlled by logic unit 655 alone or in conjunction with API unit 660.

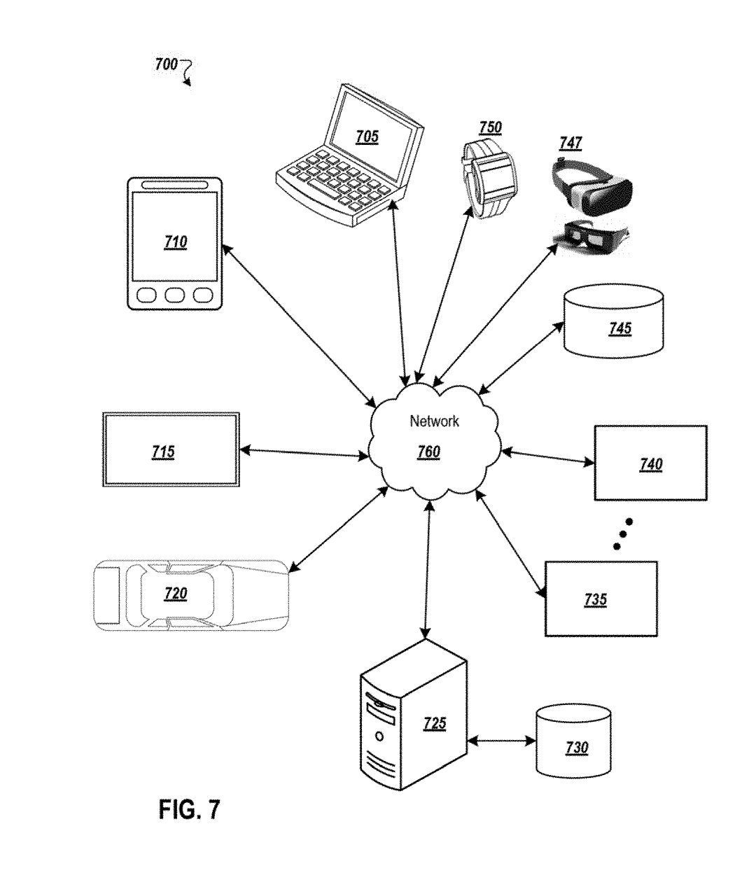

FIG. 7 shows an example environment suitable for some example implementations. Environment 700 includes devices 705-750, and each is communicatively connected to at least one other device via, for example, network 760 (e.g., by wired and/or wireless connections). Some devices may be communicatively connected to one or more storage devices 730 and 745.

An example of one or more devices 705-750 may be computing devices 905 described in regards to FIG. 9, respectively. Devices 705-750 may include, but are not limited to, a computer 705 (e.g., a laptop computing device) having a display and as associated webcam as explained above, a mobile device 710 (e.g., smartphone or tablet), a television 715, a device associated with a vehicle 720, a server computer 725, computing devices 735-740, storage devices 730 and 745, augments reality and virtual reality devices 747. As explained above, the meeting environment of the user may vary, and is not limited to an office environment.

In some implementations, devices 705-720, 750 may be considered user devices associated with the users of the enterprise. Devices 725-750 may be devices associated with client service (e.g., used by the users or administrators to provide content access control as described above and with respect to FIGS. 1-4, and/or store data, such as sensed data, pinpoint data, environment data, webpages, text, text portions, images, image portions, audios, audio segments, videos, video segments, and/or information thereabout).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as “receiving,” “applying” “determining,” “gathering,” “generating,” “processing,” “performing,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as explained above with respect to the related art, text and mouse (e.g., pointing) actions may be detected and analyzed in video documents.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

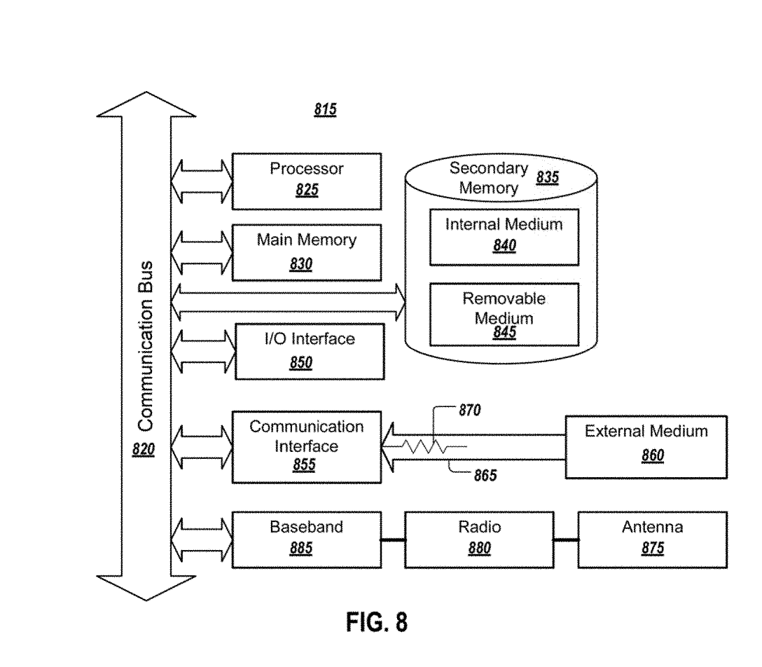

FIG. 8 provides a block diagram illustrating an example computing device or system that may be used in connection with various example implementations described herein. For example the system 805 may be used as or in conjunction with one or more of the mechanisms or processes described above, and may represent components of processors, user system(s), and/or other devices described herein. The system 805 can be a server or any conventional personal computer, or any other processor-enabled device that is capable of wired or wireless data communication. Other computer systems and/or architectures may be also used, as will be clear to those skilled in the art.

The system 805 preferably includes one or more processors, such as processor 815. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 815. Examples of processors which may be used with system 805 include, without limitation, the Pentium® processor, Core i7® processor, and Xeon® processor, all of which are available from Intel Corporation of Santa Clara, Calif.

The processor 815 is preferably connected to a communication bus 810. The communication bus 810 may include a data channel for facilitating information transfer between storage and other peripheral components of the system 810. The communication bus 810 further may provide a set of signals used for communication with the processor 815, including a data bus, address bus, and control bus (not shown). The communication bus 810 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 888 general-purpose interface bus (GPIB), IEEE 696/S-30, and the like.

System 805 preferably includes a main memory 820 and may also include a secondary memory 825. The main memory 820 provides storage of instructions and data for programs executing on the processor 815, such as one or more of the functions and/or modules discussed above. It should be understood that programs stored in the memory and executed by processor 815 may be written and/or compiled according to any suitable language, including without limitation C/C++, Java, JavaScript, Pearl, Visual Basic, .NET, and the like. The main memory 820 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 825 may optionally include an internal memory 830 and/or a removable medium 835, for example a floppy disk drive, a magnetic tape drive, a compact disc (CD) drive, a digital versatile disc (DVD) drive, other optical drive, a flash memory drive, etc. The removable medium 835 is read from and/or written to in a well-known manner. Removable storage medium 835 may be, for example, a floppy disk, magnetic tape, CD, DVD, SD card, etc.

The removable storage medium 835 is a non-transitory computer-readable medium having stored thereon computer executable code (i.e., software) and/or data. The computer software or data stored on the removable storage medium 835 is read into the system 805 for execution by the processor 815.

In alternative example implementations, secondary memory 825 may include other similar means for allowing computer programs or other data or instructions to be loaded into the system 805. Such means may include, for example, an external storage medium 850 and an interface 845. Examples of external storage medium 850 may include an external hard disk drive or an external optical drive, or and external magneto-optical drive.

Other examples of secondary memory 825 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 835 and communication interface 845, which allow software and data to be transferred from an external medium 850 to the system 805.

System 805 may include a communication interface 845. The communication interface 845 allows software and data to be transferred between system 805 and external devices (e.g. printers), networks, or information sources. For example, computer software or executable code may be transferred to system 805 from a network server via communication interface 845. Examples of communication interface 845 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 805 with a network or another computing device.

Communication interface 845 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 845 are generally in the form of electrical communication signals 860. These signals 860 are preferably provided to communication interface 845 via a communication channel 855. In one example implementation, the communication channel 855 may be a wired or wireless network, or any variety of other communication links. Communication channel 855 carries signals 860 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 820 and/or the secondary memory 825. Computer programs can also be received via communication interface 845 and stored in the main memory 820 and/or the secondary memory 825. Such computer programs, when executed, enable the system 805 to perform the various functions of the present invention as previously described.

In this description, the term “computer readable medium” is used to refer to any non-transitory computer readable storage media used to provide computer executable code (e.g., software and computer programs) to the system 805. Examples of these media include main memory 820, secondary memory 825 (including internal memory 830, removable medium 835, and external storage medium 850), and any peripheral device communicatively coupled with communication interface 845 (including a network information server or other network device). These non-transitory computer readable mediums are means for providing executable code, programming instructions, and software to the system 805.

In an example implementation that is implemented using software, the software may be stored on a computer readable medium and loaded into the system 805 by way of removable medium 835, I/O interface 840, or communication interface 845. In such an example implementation, the software is loaded into the system 805 in the form of electrical communication signals 860. The software, when executed by the processor 815, preferably causes the processor 815 to perform the inventive features and functions previously described herein.

In an example implementation, I/O interface 840 provides an interface between one or more components of system 805 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 805 also includes optional wireless communication components that facilitate wireless communication over a voice and over a data network. The wireless communication components comprise an antenna system 865, a radio system 870, and a baseband system 875. In the system 805, radio frequency (RF) signals are transmitted and received over the air by the antenna system 865 under the management of the radio system 870.

In one example implementation, the antenna system 865 may comprise one or more antennae and one or more multiplexors (not shown) that perform a switching function to provide the antenna system 865 with transmit and receive signal paths. In the receive path, received RF signals can be coupled from a multiplexor to a low-noise amplifier (not shown) that amplifies the received RF signal and sends the amplified signal to the radio system 870.

In alternative example implementations, the radio system 870 may comprise one or more radios that are configured to communicate over various frequencies. In one example implementation, the radio system 870 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 870 to the baseband system 875.

If the received signal contains audio information, then baseband system 875 decodes the signal and converts it to an analog signal. Then the signal is amplified and sent to a speaker. The baseband system 875 also receives analog audio signals from a microphone. These analog audio signals are converted to digital signals and encoded by the baseband system 875. The baseband system 875 also codes the digital signals for transmission and generates a baseband transmit audio signal that is routed to the modulator portion of the radio system 870. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 865 where the signal is switched to the antenna port for transmission.

The baseband system 875 is also communicatively coupled with the processor 815. The central processing unit 815 has access to data storage areas 820 and 825. The central processing unit 815 is preferably configured to execute instructions (i.e., computer programs or software) that can be stored in the memory 820 or the secondary memory 825. Computer programs can also be received from the baseband processor 865 and stored in the data storage area 820 or in secondary memory 825, or executed upon receipt. Such computer programs, when executed, enable the system 805 to perform the various functions of the present invention as previously described. For example, data storage areas 820 may include various software modules (not shown).

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A system for data processing comprising:
a memory;
one or more processors coupled to the memory, wherein the processor is configured to operate:
a secure core module to provide native information in response to application requests while performing in an isolated execution environment sandbox, wherein the secure core module is periodically updated with information from an insecure registry, and wherein the application requests are received from a an interaction filter that validates and forwards validated requests to the application requests to the secure core module.

2. A method comprising:
loading a native library comprising a core library in an isolated execution environment sandbox;
periodically requesting an updated version of the core library from a registry;
in response to requests from the application, authenticating the request via an interaction filter and validating information from the updated version of the core library for the request; and
delivering the validated information to the application.
